(19) United States
(12) Patent Application Publication
(10) Pub. No.: US 2015/0199329 A1
(43) Pub. Date: Jul. 16, 2015

(54) TEXT DISPLAY METHOD AND APPARATUS OF ELECTRONIC DEVICE

(71) Applicant: Samsung Electronics Co., Ltd., Suwon-si (KR)

(72) Inventor: Sangheon KIM, Gumi-si (KR)

(21) Appl. No.: 14/582,423

(22) Filed: Dec. 24, 2014

(30) Foreign Application Priority Data
Jan. 10, 2014 (KR) 10-2014-0003588

(51) Int. Cl. G06F 17/27

(52) U.S. Cl. CPC G06F 17/27

(57) ABSTRACT

A text display method and an apparatus for displaying information on an electronic device are provided. The text display method includes acquiring a text document including a plurality of paragraphs, calculating text lengths of each of the plurality of paragraphs, and displaying parts of texts of each of the plurality of paragraphs as single lines based on the calculated text lengths in order.

### CROSS-REFERENCE TO RELATED APPLICATION(S)

This application claims the benefit under 35 U.S.C. §119(a) of a Korean patent application filed on Jan. 10, 2014 in the Korean Intellectual Property Office and assigned Serial number 10-2014-0003588, the entire disclosure of which is hereby incorporated by reference.

### TECHNICAL FIELD

The present disclosure relates to a text display method and an apparatus for displaying information on an electronic device.

### BACKGROUND

There are various types of electronic devices (such as a smartphone and a tablet Personal Computer (PC)) equipped with a screen for displaying diverse information. However, some electronic devices are constrained in screen size have a drawback in that the small font size of text presented on the screen decreases legibility. Such a small screen-equipped electronic device provides the functions of adjusting the font size of the text object such as a webpage and scrolling for navigation on the webpage.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for displaying a text on the screen of the electronic device at user's disposal.

In accordance with an aspect of the present disclosure, a text display method of an electronic device is provided. The text display method includes acquiring a text document including a plurality of paragraphs, calculating text lengths of each of the plurality of paragraphs, and displaying parts of texts of each of the plurality of paragraphs as single lines based on the calculated text lengths in order.

In accordance with another aspect of the present disclosure, an electronic device is provided. The electronic device includes a communication module configured to communicate with at least one of other electronic devices and servers, a display configured to display a text document including a plurality of paragraphs, and a processor configured to analyze a structure of the text document, to calculate text lengths of each of the plurality of paragraphs, to control the display to display parts of texts of each of the plurality of paragraphs as single lines based on the calculated text lengths in order.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a network architecture including an electronic device according to various embodiments of the present disclosure;

FIG. 2 is a block diagram illustrating a configuration of a text display control module of an electronic device according to an embodiment of the present disclosure;

FIG. 3 is a diagram illustrating Hyper-Text Markup Language (HTML) information of websites according to an embodiment of the present disclosure;

FIGS. 4A, 4B, 5A, 5B, 6A, and 6B are diagrams illustrating text display screens of an electronic device according to various embodiments of the present disclosure;

FIG. 7 is a flowchart illustrating a text display method of an electronic device according to an embodiment of the present disclosure;

FIG. 8 is a flowchart illustrating a webpage display method according to an embodiment of the present disclosure; and

FIG. 9 is a block diagram illustrating a configuration of an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that the expressions “comprises” and “may comprise” are used to specify presence of disclosed function, operation, component, and the like, but do not preclude the presence of one or more functions, operations, components, and the like. It will be further understood that the terms “comprises” and/or “has” when used in this specification, specify the presence of stated feature, number, step, operation, component, element, or a combination thereof but do not preclude the presence or addition of one or more other features, numbers, steps, operations, components, elements, or combinations thereof

In the present disclosure, the expression “and/or” is taken as specific disclosure of each and any combination of enumerated things. For example, A and/or B is to be taken as specific disclosure of each of A, B, and A and B.

As used herein, terms such as “first,” “second,” and the like, are used to describe various components but not restrict the corresponding components. However, it is obvious that the components should not be defined by these terms. The terms are used only for distinguishing one component from another component. For example, a first component may be referred to as a second component and likewise, a second component may also be referred to as a first component, without departing from the teaching of the inventive concept.

It will be understood that when an element or layer is referred to as being “on”, “connected to” or “coupled to” another element or layer, the element or layer may be directly on, connected or coupled to the other element or layer or intervening elements or layers may be present. In contrast, when an element is referred to as being “directly on,” “directly connected to” or “directly coupled to” another element or layer, there are no intervening elements or layers present.

The terminology used herein is for the purpose of describing particular embodiments only and is not intended to be limiting of the present disclosure. As used herein, the singular forms are intended to include the plural forms as well, unless the context clearly indicates otherwise.

Unless otherwise defined, all terms used herein have the same meaning as commonly understood by one of ordinary skill in the art to which this disclosure pertains, and should be interpreted neither as having an excessively comprehensive meaning nor as having an excessively contracted meaning. The general terms used herein should be interpreted according to the definitions in the dictionary or in the context and should not be interpreted as an excessively contracted meaning.

In the following description, the electronic device may be a device having a communication function. Examples of the electronic device may include at least one of a smartphone, a tablet Personal Computer (PC), a mobile phone, a video phone, an electronic book (ebook) reader, a desktop PC, a laptop PC, a netbook PC, a Personal Digital Assistant (PDA), a Portable Multimedia Player (PMP), an Moving Picture Experts Group Audio Layer III (MP3) player, a mobile medical appliance, a camera, a wearable device (e.g., head-mounted-device (HMD) such as electronic glasses), an electronic clothing, an electronic bracelet, an electronic neckless, an appcessory, an electronic tattoo, and a smart watch.

According to various embodiments of the present disclosure, examples of the electronic device may be a smart home appliance having a communication function. Examples of the smart home appliance may include at least one of a television (TV), a Digital Video Disk (DVD) player, an audio player, a refrigerator, an air conditioner, a cleaner, an oven, a microwave oven, a laundry machine, an air cleaner, a set-top box, a TV box (e.g., Samsung HomeSync™, Apple TV™, and Google TV™), a game console, an electronic dictionary, an electronic key, a camcorder, and an electronic frame.

According to various embodiments of the present disclosure, examples of the electronic device may include at least one of a medical appliance (e.g., a Magnetic Resonance Angiography (MRA), a Magnetic Resonance Imaging (MRI), a Computed Tomography (CT), a camera, and an ultrasonic device), a navigation device, a Global Positioning System (GPS) receiver, an Event Data Recorder (EDR), a Flight Data Recorder (FDR), a car infotainment device, an electronic equipment for ship (e.g., marine navigation device and gyro compass), an avionics device, a security device, a Head Up Display (HUD), an industrial or home robot, an Automatic Teller Machine (ATM) of a financial institution, and a Point Of Sales (POS).

According to various embodiments of the present disclosure, examples of the electronic device may include furniture or part of building/construction which has a communication function, an electronic board, an electronic signature receiving device, a projector, and a metering device (e.g., water, electricity, and electric wave metering devices). According to an embodiment of the present disclosure, the electronic device may be one or any combination of the above enumerated devices. According to an embodiment of the present disclosure, the electronic device may be a flexible device. However, it is obvious to those of ordinary skill in the art that the electronic device of the present disclosure is not limited to the above devices.

A description is made of the electronic device according to various embodiments of the present disclosure with reference to accompanying drawings hereinafter. In the description of the various embodiments of the present disclosure, the term ‘user’ may denote a person or a device (e.g., intelligent electronic device) which uses the electronic device.

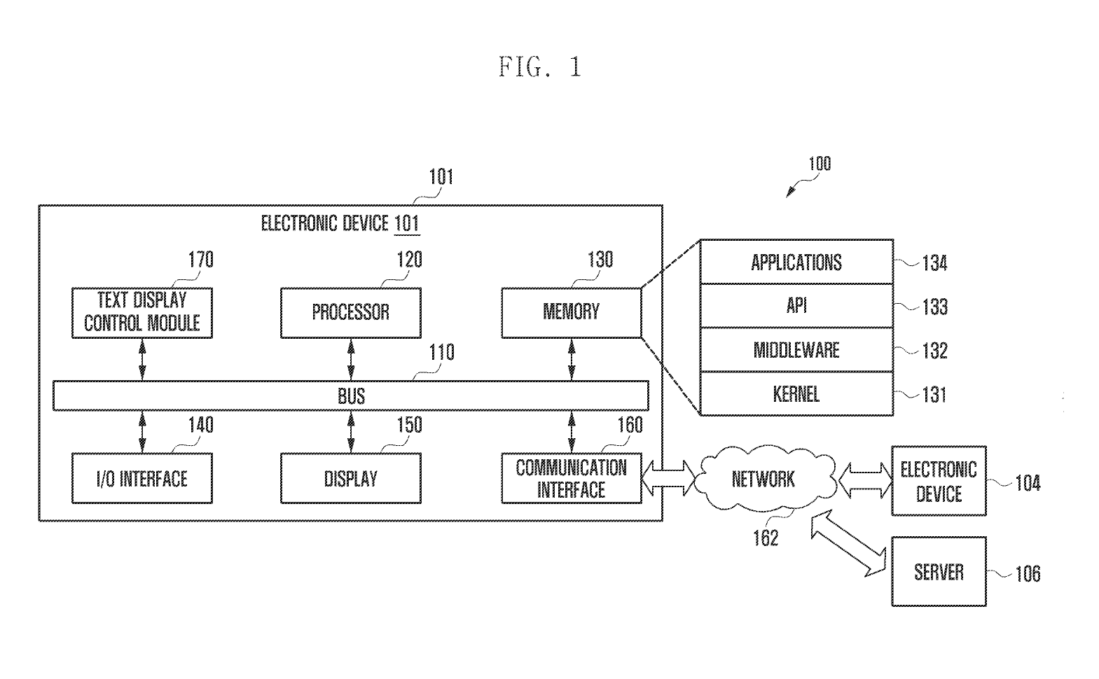

FIG. 1 is a diagram illustrating a network architecture including an electronic device according to various embodiments of the present disclosure.

Referring to FIG. 1, a network architecture 100 includes an electronic device 101. The electronic device 101 includes a bus 110, a processor 120, a memory 130, an input/output interface 140, a display 150, a communication interface 160, and a text display control module 170.

The bus 110 may be a circuitry which connects the aforementioned components to each other to communicate signals (e.g., control messages) therebetween.

The processor 120 receives a command from any of the aforementioned components (e.g., the memory 130, the input/output interface 140, the display 150, the communication interface 160, and the text display control module 170) through the bus 110, interprets the command, and executes operation or data processing according to the decrypted command.

The memory 130 may store the command or data received from the processor 120 or other components (e.g., the input/output interface 140, the display 150, the communication interface 160, the text display control module 170, and the like) or generated by the processor 120 or other components. The memory 130 may store program modules including a kernel 131, middleware 132, an Application Programming Interface (API) 133, applications 134, and the like. Each programming module may be implemented as software, firmware, hardware, and any combination thereof.

The kernel 131 may control or manage the system resources (e.g., bus 110, processor 120, and memory 130) for use in executing the operation or function implemented with the middleware 132, the API 133, or the application 134. The kernel 131 also may provide an interface allowing the middleware 132, API 133, or application 134 to access the components of the electronic device 101 to control or manage.

The middleware 132 may work as a relay of data communicated between the API 133 or the application 134 and the kernel 131. The middle 132 may execute control of the task requests from the applications 134 in such a way of assigning priority for use of the system resource (e.g., the bus 110, the processor 120, and the memory 130) of the electronic device 101 to at least one of the applications 134.

The API 133 is the interface for the applications 134 to control the function provided by the kernel 131 or the middleware 132 and may include at least one interface or function (e.g., command) for file control, window control, image control, or text control.

According to various embodiments of the present disclosure, the applications 134 may include a Short Messaging Service/Multimedia Messaging Service (SMS/MMS) application, an email application, a calendar application, an alarm application, a health care application (e.g., application of measuring quantity of motion or blood sugar level), and an environmental information application (e.g., atmospheric pressure, humidity and temperature applications). Additionally or alternatively, the application 134 may be an application related to information exchange between the electronic device 101 and other external electronic device (e.g., electronic device 104). Examples of the information exchange application may include a notification relay application for relaying specific information to the external electronic device 104 and a device management application for managing the external electronic device.

For example, the notification relay application may be provided with a function of relaying the alarm information generated by the other applications (e.g., the SMS/MMS application, the email application, the health care application, and the environmental information application) of the electronic device 101 to an external electronic device (e.g., electronic device 104). Additionally or alternatively, the notification relay application may provide the user with the notification information received from an external electronic device (e.g., electronic device 104). The electronic device application may manage (e.g., install, delete, and update) the function of an external electronic device (e.g., turn-on/off of the electronic device 104 (or a part of the electronic device 104) or adjustment of the brightness (or resolution) of the display) which communicates with the electronic device 101 or the service (e.g., communication or messaging service) provided by the external electronic device or an application running on the external device.

According to various embodiments of the present disclosure, the applications 134 may include an application designated according to the property (e.g., type) of an external electronic device (e.g., the electronic device 104). If the external electronic device is the MP3 player, the applications 134 may include a music playback application. Similarly, if the external electronic device is a mobile medical appliance, the applications 134 may include a health care application. According to an embodiment of the present disclosure, the application 134 may include at least one of applications designated to the electronic device 101 or the applications received from the external electronic device (e.g., a server 106 and electronic device 104).

The input/output interface 140 delivers the command or data input by the user through with an input/output device (e.g., a sensor, a keyboard, and a touchscreen) to the processor 120, the memory 130, the communication interface 160, and/or the text display control module 170 through the bus 110. For example, the input/output interface 140 may provide the processor 120 with the data corresponding to the touch may by the user on the touchscreen. The input/output interface 140 may output the command or data (which is received from the processor 120, memory 130, communication interface 160, or the text display control module 170 through the bus 110) through the input/output device (e.g., speaker and display). For example, the input/output interface 140 may output the voice data processed by the processor 120 to the user through the speaker.

The display 150 may present various information (e.g., multimedia data and text data) to the user.

The communication interface 160 may establish a communication connection of the electronic device 101 with an external device (e.g., electronic device 104 and server 106). For example, the communication interface 160 connects to the network 162 through a wireless or wired link for communication with the external device. Examples of the wireless communication technology may include wireless fidelity (Wi-Fi), Bluetooth (BT), Near Field Communication (NFC), GPS, and cellular communication technology (e.g., Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM)). Examples of the wired communication technology may include Universal Serial Bus (USB), High Definition Multimedia Interface (HDMI), Recommended Standard 232 (RS-232), and Plain Old Telephone Service (POTS).

According to an embodiment of the present disclosure, the network 162 may be a telecommunication network. The communication network may include at least one of computer network, Internet, Internet of Things, and telephone network. According to an embodiment of the present disclosure, the communication protocol between the electronic device 101 and an external device (e.g., transport layer protocol, data link layer protocol, and physical layer protocol) may be supported by at least one of the applications 134, API 133, middleware 132, kernel 131, and communication interface 160.

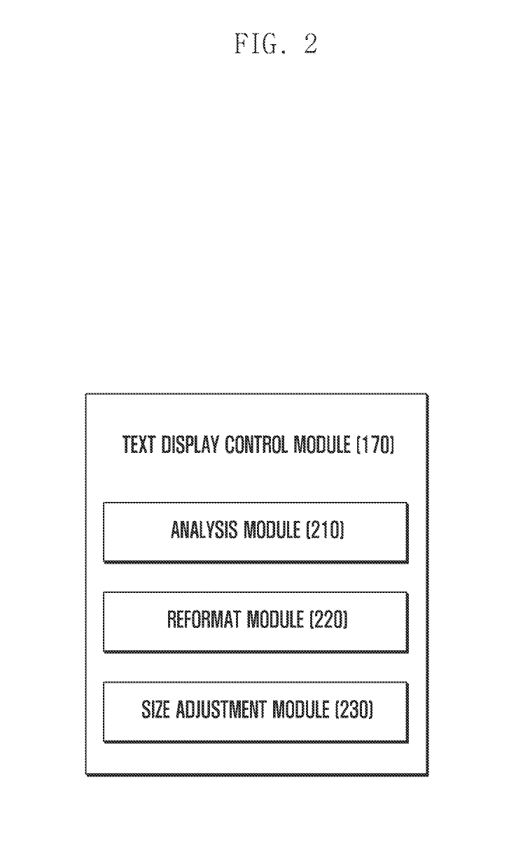

The text display control module 170 processes at least part of the text information acquired from other components (e.g., the processor 120, the memory 130, the input/output interface 140, and the communication interface 160) and provides the user with the processing result. For example, the text display control module 170 may control at least part of the functions of the electronic device 101 to interoperate with other electronic devices (e.g., the electronic device 104 and the server 106) with or without using of the processor 120. A description is made of the text display control module 170 in more detail hereinafter with reference to FIG. 2.

FIG. 2 is a block diagram illustrating a configuration of a text display control module of an electronic device according to an embodiment of the present disclosure.

Referring to FIG. 2, the text display control module 170 includes an analysis module 210, a reformat module 220, and a size adjustment module 230.

The analysis module 210 analyzes a text document acquired from another device (e.g., the electronic device 104 and the server 106) or stored in the electronic device 101 and evaluates the text structure of the text document. The text document denotes the data written in an electronic format suited for transmission/reception and storage and may include at last one paragraph of an ebook, a file type electronic document, and a webpage provided through a web server.

The analysis module 210 analyzes the text structure based on the whole layout of the text document and evaluates the paragraph components of the text structure.

According to an embodiment of the present disclosure, the analysis module 210 may acquire webpage information based on the communication address information of a web server. The electronic device 101 may receive the webpage information (e.g., a Hyper-Text Markup Language (HTML) document) from the webserver by means of the communication device. The analysis module 210 may performs tokenizing and parsing on the webpage information. Through the parsing process, the webpage information may be decomposed into the components such as tags and content and presented in the form of tree-structured data. For example, the tree-structured data may be structured in the Document Object Model (DOM) tree structure in which the webpage information is formed with a plurality of components arranged vertically below the highest level component and a plurality of optional components belonging to the selected component that are arranged horizontally on the same line. The analysis module 210 analyzes the components included in the DOM tree structure to evaluate the paragraph components based on the paragraph attribute, e.g., div, p, and itemprop tags among the block level attributes. For example, the tag components of the webpage information include a head, a title, meta, and a body, and the body component needs an identifier for applying a design or an action through Cascading Style Sheets (CSS) or a script, the identifier being designated id and class attributes and sorted into a block level attribute for defining line break and an inline attribute for non-line break. For example, the block level attribute may include UL, li, ol, DL, dt, dd, p, itemprop tags, and the inline attribute may include a, ima, select, input, and span tags.

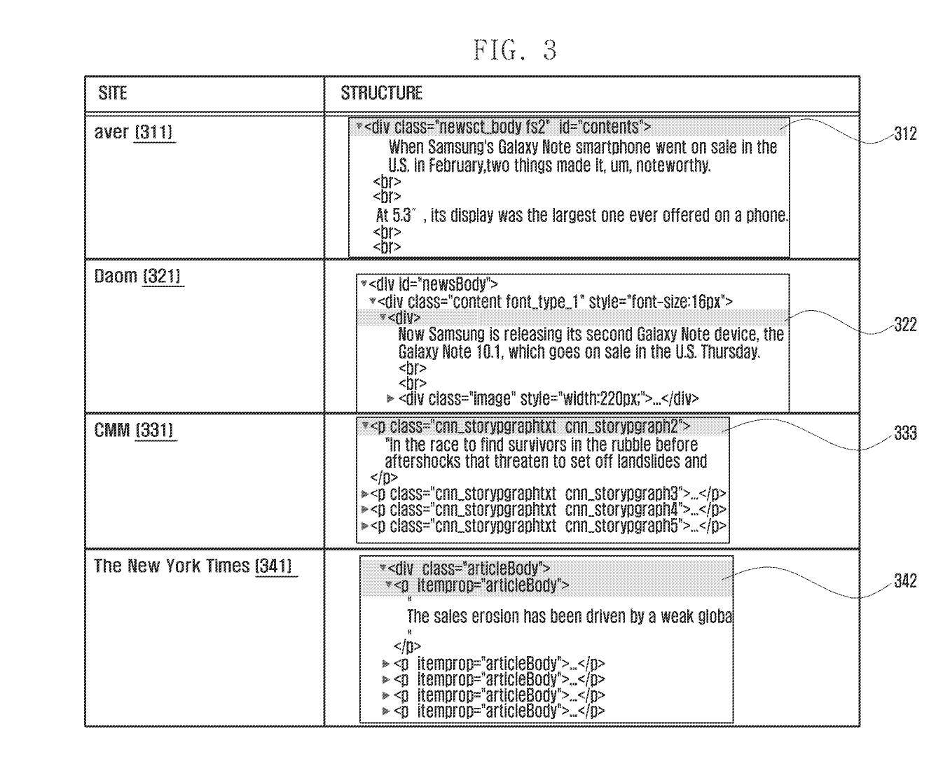

FIG. 3 is a diagram illustrating HTML information of websites according to an embodiment of the present disclosure.

Referring to FIG. 3, the electronic device 101 may access the websites 311, 321, 331, and 341 to receive webpage documents (e.g., HTML file). Each website is built with various features abiding by the standard, and the electronic device 101 parses the webpage documents to evaluate the attributed for discerning the paragraphs. For example, the paragraph component is recognized based on the div and P tags in the website document 311 as denoted by reference number 312. Also, the paragraph component is recognized based on the div tag in the second website 321 as denoted by reference number 322 and the p tag in the third website 331 as denoted by reference number 333. In the case of the fourth website 341, the paragraph component is recognized based on the div, p, and itemprop tags as denoted by reference number 342.

According to an embodiment of the present disclosure, the analysis module 210 may evaluate the paragraph component based on the paragraph symbol (e.g., enter symbol) included in the text information and the text length information marked on a single line.

The analysis module 210 may calculate the whole length of the text per paragraph based on the text data included in the paragraph component and value n which is the length of a single line on the display screen. For example, the analysis module 210 calculates the whole length of the text of paragraph and value n in unit of byte.

According to an embodiment of the present disclosure, the analysis module 210 may calculate n based on the resolution of the display connected functionally with the electronic device 101 and the font size of the text.

The analysis module 210 determines whether the text length of each paragraph is greater than n and sends the reformat module 220 the paragraph folding information.

The reformat module 220 reformats the structure of the text document based on the folding information of the paragraph. The reformat module 220 may update the rendered text document.

According to an embodiment of the present disclosure, the reformat module 220 evaluates the value of n for single line and reformat the text document by folding the paragraph into single line corresponding to n. The reformat module 220 renders the reformatted text document with the structure of the original text document to acquire the rendered text document information. For example, the reformat module may acquire a render tree structure based on the DOM tree structure of the original webpage document and update the webpage document based on the render tree structure. In this case, the electronic device 101 may send the render tree structure information to the web server which provides the webpage document.

The size adjustment module 230 may display the updated text document on the display screen connected functionally to the electronic device 101. For example, the size adjustment module 230 may display the webpage screen updated in the render tree structure by means of a web browser. The size adjustment module 230 may adjust the text size of each paragraph in consideration of the number of folded paragraphs, the screen resolution, the text size, and a text length of the whole text document.

According to an embodiment of the present disclosure, the size adjustment module 230 may display the text document in the folded structure through the display which is connected functionally with the electronic device 101.

According to an embodiment of the present disclosure, the size adjustment module 230 may control such that one of the folded paragraphs is selected and displayed as stretched on the display connected functionally with the electronic device 101.

According to various embodiments of the present disclosure, the electronic device 101 may include a communication module for communication with at least one other electronic device and a server, a display for displaying the text document including a plurality of paragraphs, and a processor for analyzing the text document structure, calculating the text lengths of the paragraphs of the text document, and folds the paragraphs into respective single text lines arranged on the display.

The processor may include an analysis module which decomposes the text document into components, evaluates the paragraph components among them, discerns the paragraphs in the text document, and generating the folding information for the paragraphs, a reformat module which reformats the structure of the text document based on the folding information, renders the reformatted information and text document, and updates the reformatted text document, and a size adjustment module which displays the reformatted text document on the display and adjusting the text size of each paragraph based on the number of folded paragraph, screen resolution, text size, and text length of the whole text document.

The processor may calculate the length of the whole text of each paragraph included in the text document and the single line length n of the display screen and, if the text length of each paragraph it greater than n, generates the folding information of the corresponding paragraph.

The processor may calculate the value n based on the display resolution and text font size.

The processor may reformat the structure of the paragraphs such that the paragraphs are folded into per-paragraph single text lines while hiding the rest of the parts thereof.

If one of the single-lined paragraphs is selected, the processor may control to display the whole original text of the selected paragraph.

The processor may control to display the whole original text of the selected paragraph so as to be distinguished from others in at least one of size, color, effect, and type.

The processor may control such that each single-lined paragraph is presented with a folding indicator informing of the existence of a hidden part of the text.

Although the description is directed to display a webpage, the present disclosure is not limited thereto but applicable to the case of displaying files and memos including at least one text paragraph.

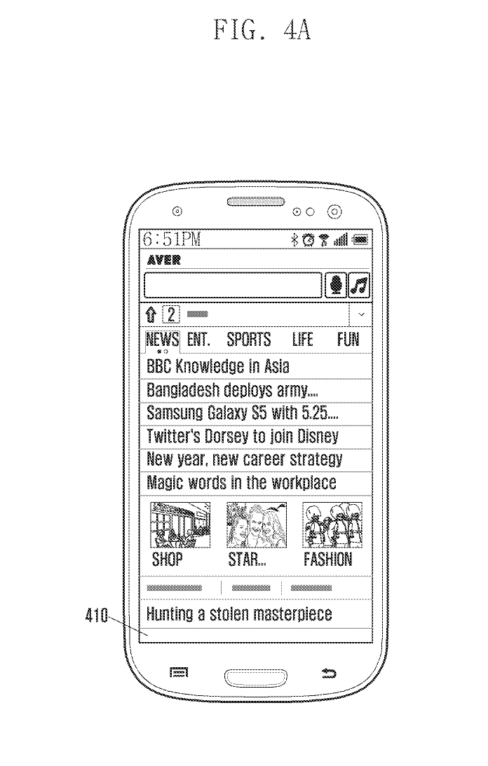

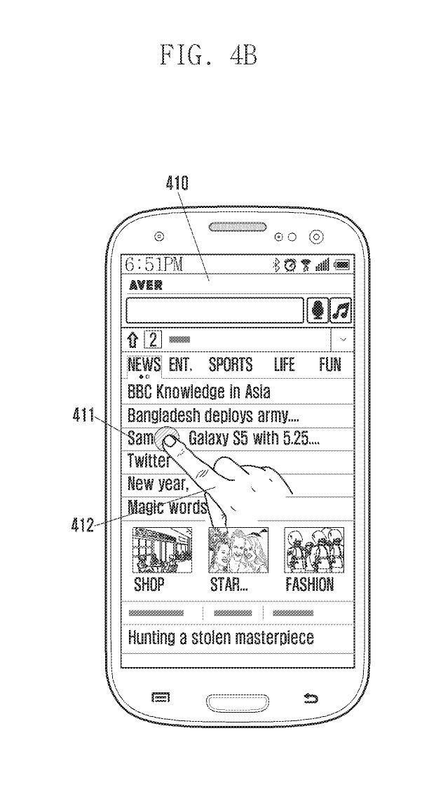

FIGS. 4A, 4B, 5A, 5B, 6A, and 6B are diagrams illustrating text display screens of an electronic device according to various embodiments of the present disclosure.

Referring to FIGS. 4A and 4B, the electronic device 101 according to various embodiments of the present disclosure may display a webpage document. For this purpose, the user may execute a web browser and send a predetermined web server a request for access thereto under the user input control. If it is an initial access of the electronic device 101, the web server may send the electronic device 101 the webpage information on the initial access page. The webpage information may include an HTML document and link information on the links of the HTML document. For example, the webpage information may provide graphics, audio, video, program file, and advertisement data in the form of hypertext as well as the text data.

According to an embodiment of the present disclosure, the electronic device 101 may display the main page screen 410 of the website on the display connected functionally with the electronic device 101 as shown in FIG. 4A. The main page screen 410 of the website may include a plurality of link items 411 having link information associated with other webpage screens. The user may select specific link item as denoted by reference number 412 on the main page screen 410 as shown in FIG. 4B.

Then the electronic device 101 may receive the webpage (e.g., HTML document) associated with the link item 411 in correspondence to the user's selection input. At this time, the webpage may include at least one paragraph.

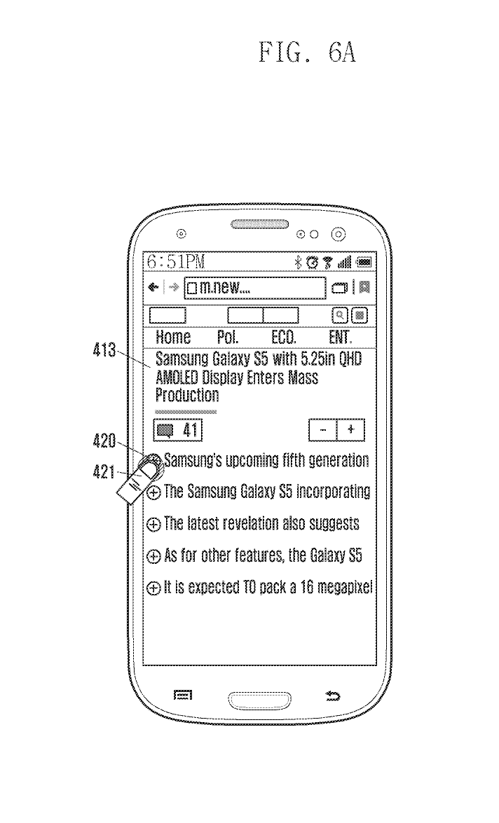

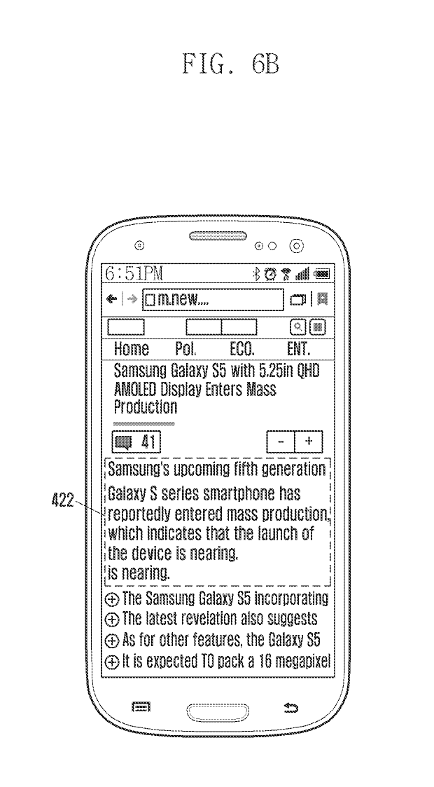

If the webpage including at least one paragraph is received, the electronic device 101 may reformat the text structure of the paragraph so as to be displayed in the form of folded single-line paragraphs on the webpage screen as denoted by reference number 421 as shown in FIG. 6A.

According to an embodiment of the present disclosure, the electronic device 101 may select one of the paragraphs on the webpage screen 421, unfold the selected paragraph, and display the whole text of the paragraph as denoted by reference number 422. For example, the electronic device 101 may unfold the paragraph arranged at the top of the screen among the paragraphs on the webpage screen and displays the original text of the paragraph as denoted by reference number 422 as shown in FIG. 6B.

According to an embodiment of the present disclosure, the electronic device 101 may display the text of the unfolded paragraph so as to be distinguished from the rest paragraphs in at least one of text size, color, effect, and type. For example, the electronic device 101 may display the text of the unfolded paragraph in enlarged size and changed color. In this way, it is possible to improve the legibility of the paragraph selected by user in the webpage document.

According to an embodiment of the present disclosure, the electronic device 101 is capable of discerning the paragraphs on a webpage and folding the paragraphs so as to be displayed as singling-lined paragraphs on the webpage screen.

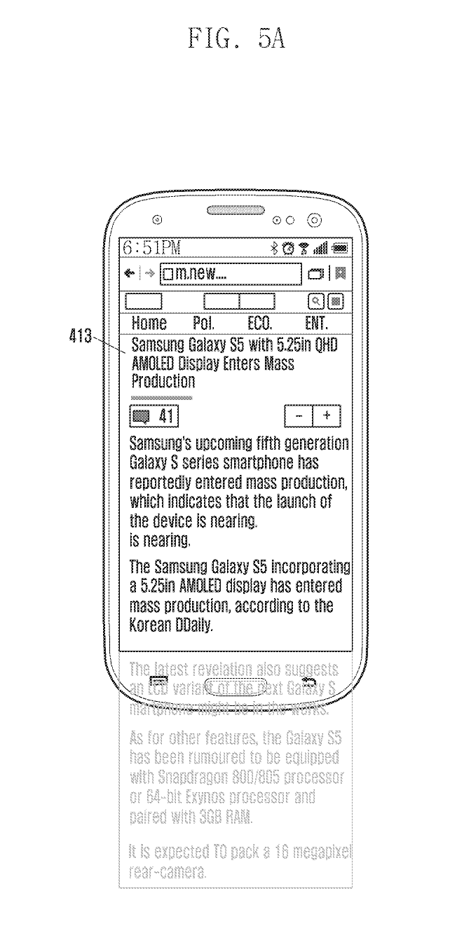

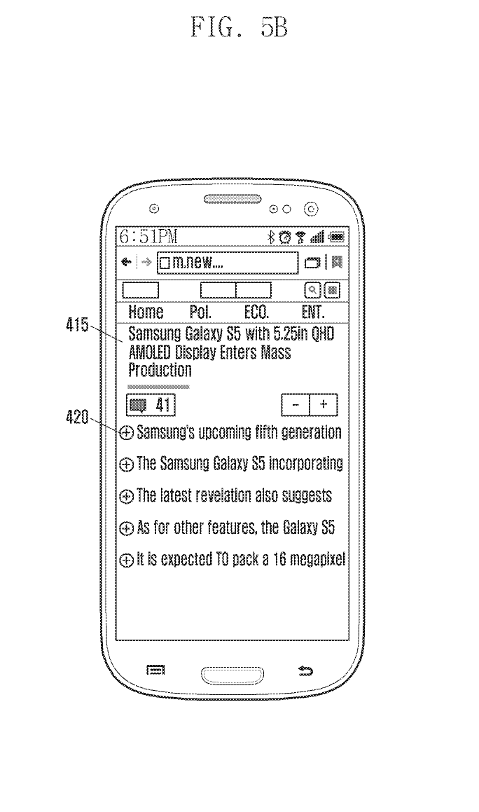

Referring to FIG. 5A, the electronic device 101 with a size-constrained screen is capable of displaying the parts of the text document included in the webpage screen 413 on the display connected functionally with the electronic device 101 as shown in FIG. 5A. In the case according to the related art, the user has to navigate the webpage 413 using the scroll function on the display screen to see another part of the text document included in the webpage screen 413. The electronic device 101 scrolls the webpage across the display screen to show the other part of the document as shown in FIG. 5A.

According to various embodiments of the present disclosure, the electronic device 101 may analyze the webpage document requiring the scroll function to discern the paragraphs of the text included in the webpage and display the webpage 415 with the folded paragraphs as shown in FIG. 5B.

Referring to FIG. 5B, the electronic device 101 is capable of displaying the webpage 415 with the folded paragraphs. The electronic device 101 may control such that the paragraphs are folded to be shown as single-lined paragraphs. In this case, the electronic device 101 may determine the text length of the single-lined paragraph based on the display resolution and text size.

According to an embodiment of the present disclosure, the electronic device 101 may control such that the folding indicator (e.g., icon and text) informing of the folded state is displayed along with each single-lined paragraph.

Referring to FIGS. 6A and 6B, the user may select the folding indicator 420 or one of the folded paragraphs on the webpage screen 415 as denoted by reference number 421. The electronic device 101 detects the user's selection of the folding indicator 420 and thus spreads (unfolds) the paragraph corresponding to the folding indicator 420 to show the whole text 422 of the paragraph on the screen.

According to an embodiment of the present disclosure, if the folding indicator of another folded paragraph is selected in the state that the whole text of the unfolded paragraph is displayed, the electronic device 101 folds the currently unfolded paragraphs and unfolds the folded paragraph corresponding to the selected folding indicator.

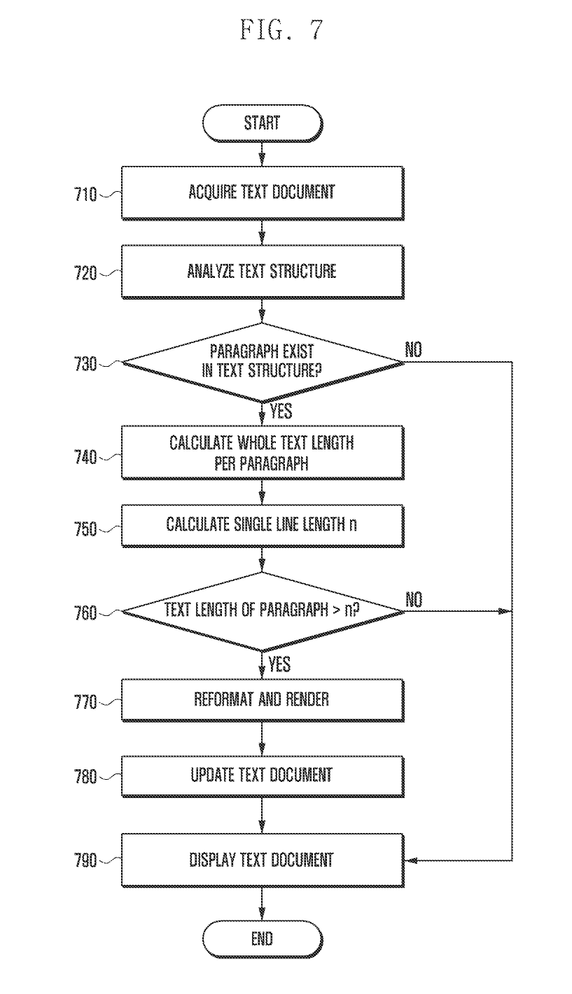

FIG. 7 is a flowchart illustrating a text display method of an electronic device according to an embodiment of the present disclosure.

Referring to FIG. 7, the electronic device 101 acquires a text document according to a user input or a predetermined schedule at operation 710. For example, the electronic device 101 may acquire the data of a text document (e.g., the webpage and the ebook document) stored in the memory or received from a web server.

The electronic device 101 analyzes the structure of the text document at operation 720 and determines whether any paragraph exists in the structure of the text document at operation 730.

According to an embodiment of the present disclosure, the electronic device 101 may compare the title of the link item selected by the user and the components of the text document to evaluate the location of the information on a specific page. The electronic device 101 may evaluate the whole layout of the text document of the specific page and the paragraph components among the components of the whole layout structure.

The electronic device 101 determines whether there is any paragraph based on the paragraph components and, if there is any paragraph, the procedure goes to operation 740 and, otherwise, jumps to operation 790 to display the text document on the display screen.

If any paragraph exists in the text document, the electronic device 101 calculates the text length of each paragraph at operation 740 and the single line length n of the display screen at operation 750. For example, the electronic device 101 may calculate the whole text length and the signal line length n in unit of byte but is not limited thereto. The single line length n may be determined based on the resolution of the display screen and the text font size.

The electronic device 101 determines whether the whole text length of each paragraph is longer than the signal line length n at operation 760 and, if so, reformats and renders the text document at operation 770. Otherwise, if the electronic device 101 determines whether the whole text length of each paragraph is less than or equal to the signal line length n, skip to operation 790.

According to an embodiment of the present disclosure, the electronic device 101 may configure the document such that only the most parts of the texts of the respective paragraphs are hidden with the exception of single lines thereof. For example, the electronic device 101 may reformat the document such that the respective paragraphs are folded to be displayed as single-lined paragraphs and, when one of the single-lined paragraphs is selected, the selected single-lined paragraph is unfolded into the original paragraph showing its whole text on the screen.

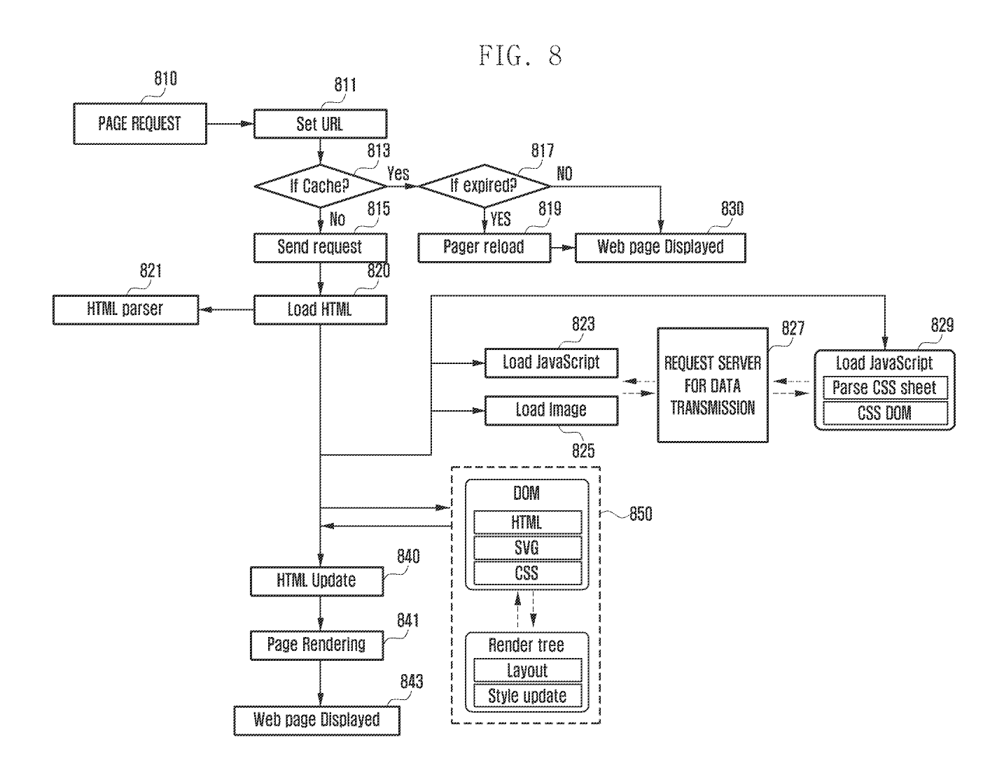

According to an embodiment of the present disclosure, the electronic device 101 may generate a render tree information using the folding information of the paragraphs and text length information corresponding to the value n based on the DOM tree structure. The rendering process and render tree are clarified more in the description of the webpage loading procedure of FIG. 8.

The electronic device 101 renders the text document so as to be updated to the render tree structure at operation 780 and displays the text document at operation 790.

According to an embodiment of the present disclosure, the electronic device 101 folds the respective paragraphs included in the text document into the single-lined texts. According to an embodiment of the present disclosure, the electronic device 101 may control such that the paragraph arranged at the top of the screen is displayed in the state of unfolded whole text on the screen. At this time, the electronic device 101 may display the whole text of the unfolded paragraph in the state of being enlarged in consideration of the screen resolution and text font size.

A description is made of the webpage loading procedure of the electronic device 101 hereinafter.

FIG. 8 is a flowchart illustrating a webpage display method according to an embodiment of the present disclosure.

Referring to FIG. 8, the user requests for a webpage through a web browser at operation 810. The user enters the webpage Uniform Resource Locator (URL) information to request a web server for the webpage data based on the URL information at operation 811. Then the electronic device 101 receives the webpage data corresponding to the URL information from the web server. For example, the electronic device 101 may request the web server for the webpage data using a Hyper-Text Transfer Protocol (HTTP) GET/POST method. The web server may send the electronic device 101 the data formatted in HTML.

In the course of loading the webpage, the electronic device 101 determines whether any data on the requested page exists based on the header information of the received webpage data and the storage module, e.g., cache, of the electronic device 101 at operation 813. If no data on the requested page exists in the cache, the electronic device 101 requests the web server for the HTML document information.

If the information on the requested page exists in the cache, the electronic device 101 determines whether the webpage has been expired at operation 817. According to an embodiment of the present disclosure, the electronic device 101 determines the expiry of the webpage by comparing the last modified time included in the HTTP header information and the valid caching time (max-age) value.

If the webpage has expired, the electronic device 101 reloads the page to receive the HTML document information from the web server at operation 819. The electronic device 101 displays the webpage on the display screen connected functionally with the electronic device 101 based on the reloaded HTML document or cached HTML document at operation 830.

If the HTML document is received from the web server in response to the HTML document request, the electronic device 101 performs tokening and parsing on the HTML file by means of the HTML parser at operation 821. Through the parsing process, the HTML file is decomposed into HTML components such as HTML tags and contents to generate data in the HTML tree structure.

The electronic device 101 may request for the access to the external resource related to additional HTML, CSS, JavaScript, and image file and downloads them at operations 823 and 825 in the course of parsing the HTML document. If there is no download of data on the external resource, the electronic device requests the web server for the data on the external resource and, if the request external resource data is downloaded, executes operation related to the downloaded external resource at operations 827 and 829.

In the case of the CSS file, the electronic device 101 extracts the style information of the webpage through CSS parsing process and updates the style table information. In the case of the JavaScript file, the electronic device 101 executes a function of DOM tree structure update or resource request by performing script processing on the designated execution target code by means of a JavaScript engine.

If the HTML document and external resource data are downloaded through this process, the electronic device 101 evaluates the paragraphs included in the webpage based on the DOM tree structure and reformat the webpage to generate the render tree for folding the respective paragraphs at operation 850. The electronic device 101 updates the HTML document based on the render tree at operation 840 and renders the webpage at operation 841. The electronic device 101 may display the webpage 843 reformatted based on the render tree on the display screen.

According to various embodiments of the present disclosure, the text display method of the electronic device 101 may include acquiring a text document including a plurality paragraphs, calculating text lengths of the respective paragraphs included in the text document, and displaying single lines of the texts of the respective paragraphs based on the calculated text lengths in order.

In an implementation, displaying the single lines includes calculating whole data length of each paragraph by analyzing a text structure of the text document, calculating a single line text length of a display of the electronic device, and displaying, when the whole text length is longer than the single line text length, part of the text of the paragraph.

In an implementation, displaying the single lines includes hiding part of the whole text of the paragraph in a folded state and presenting the rest of the part as a single-lined paragraph on the display screen.

In an implementation, displaying the single lines includes displaying, when one of the single-lined paragraphs is selected, the whole text of the selected paragraph.

In an implementation, displaying the single lines includes presenting the whole text of the selected paragraph to be distinguished from the texts of other paragraphs in at least one of size, color, effect, and type.

In an implementation, displaying the single lines includes analyzing a structure of the text document, evaluating paragraph components in the text document, determining single line text length to be presented per paragraph based on the text lengths of the paragraphs, reformatting the text document into the text document having folded paragraphs based on the display resolution of the electronic device 101, and font size of the determined text, and display the reformatted text document.

In an implementation, reformatting the text document includes generating a reformatted render tree based on the tree structure of the text document.

In an implementation, displaying the single lines includes displaying a folding indicator for informing of existence of hidden text information per paragraph.

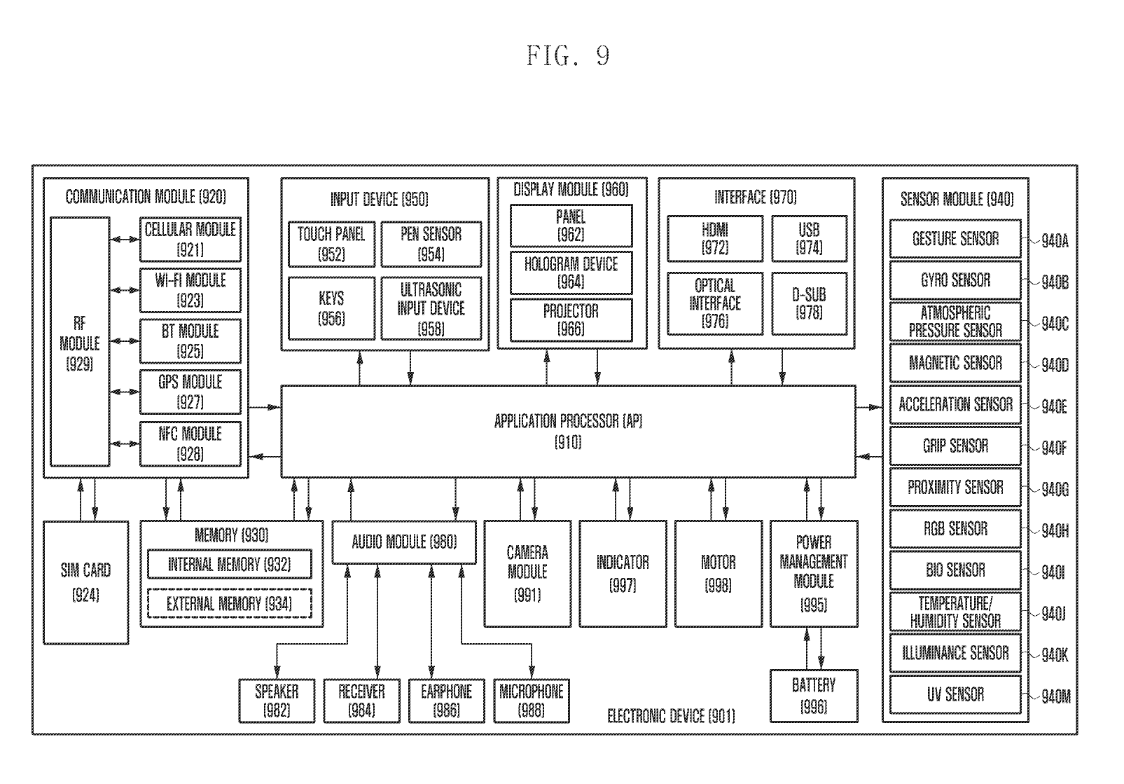

FIG. 9 is a block diagram illustrating a configuration of an electronic device according to various embodiments of the present disclosure. The electronic device of FIG. 9 may be of the whole or a part of the electronic device 101.

Referring to FIG. 9, the electronic device 901 may include an Application Processor (AP) 910, a communication module 920, a Subscriber Identity Module (SIM) card 924, a memory 930, a sensor module 940, an input device 950, a display 960, an interface 970, an audio module 980, a camera module 991, a power management module 995, a battery 996, an indicator 997, and a motor 998.

The AP 910 may operate an Operating System (OS) and/or application programs to control a plurality of hardware and/or software components connected to the AP 910 and perform data-processing and operations on multimedia data. For example, the AP 910 may be implemented in the form of System on Chip (SoC). According to an embodiment of the present disclosure, the AP 910 may include a Graphic Processing Unit (GPU) (not shown).

The communication module 920 (e.g., communication interface 160) may perform data communication with other electronic devices (e.g., electronic device 104 and server 106) through a network. According to an embodiment of the present disclosure, the communication module 920 may include a cellular module 921, a Wi-Fi module 923, a BT module 925, a GPS module 927, an NFC module 928, and a Radio Frequency (RF) module 929.

The cellular module 921 is responsible for voice and video communication, text messaging, and Internet access services through a communication network (e.g., LTE, LTE-A, CDMA, WCDMA, UMTS, WiBro, and GSM networks). The cellular module 921 may perform identification and authentication of electronic devices in the communication network using the SIM card 924. According to an embodiment of the present disclosure, the cellular module 921 may perform at least one of the functions of the AP 910. For example, the cellular module 921 may perform at least a part of the multimedia control function.

According to an embodiment of the present disclosure, the cellular module 921 may include a Communication Processor (CP). The cellular module 921 may be implemented in the form of SoC. Although the cellular module 921 (e.g., communication processor), the memory 930, and the power management module 995 are depicted as independent components separated from the AP 910, the present disclosure is not limited thereto but may be embodied in a way that the AP includes at least one of the components (e.g., cellular module 921).

According to an embodiment of the present disclosure, each of the AP 910 and the cellular module 921 (e.g., communication processor) may load a command or data received from at least one of the components on a non-volatile or volatile memory and process the command or data. The AP 910 or the cellular module 921 may store the data received from other components or generated by at least one of other components in the non-volatile memory.

Each of the Wi-Fi module 923, the BT module 925, the GPS module 927, and the NFC module 928 may include a processor for processing the data the communication module 920 transmits/receives. Although the cellular module 921, the Wi-Fi module 923, the BT module 925, the GPS module 927, and the NFC module 928 are depicted as independent blocks, at least two of them (e.g., communication processor corresponding to the cellular module 921 and Wi-Fi processor corresponding to the Wi-Fi module 923) may be integrated in the form of SoC.

The RF module 929 is responsible for data communication (e.g., transmitting/receiving RF signals). Although not depicted, the RF module 929 may include a transceiver, a Power Amp Module (PAM), a frequency filter, and a Low Noise Amplifier (LNA). The RF module 929 also may include the elements for transmitting/receiving electric wave in free space (e.g., conductor or conductive wire). Although FIG. 9 is directed to the case where the Wi-Fi module 923, the BT module 925, the GPS module 927, and the NFC module 928 are sharing the RF module 929, the present disclosure is not limited thereto but may be embodied in a way that at least one of the Wi-Fi module 923, the BT module 925, the GPS module 927, and the NFC module 928 transmits/receives RF signals an independent RF module.

The SIM card 924 may be designed so as to be inserted into a slot formed at a predetermined position of the electronic device. The SIM card 924 may store unique identity information (e.g., Integrated Circuit Card Identifier (ICCID)) or subscriber information (e.g., International Mobile Subscriber Identity (IMSI)).

The memory 930 (e.g., memory 130) may include at least one of the internal memory 932 and an external memory 934. The internal memory 932 may include at least one of a volatile memory (e.g., Dynamic Random Access Memory (DRAM), Static RAM (SRAM), Synchronous Dynamic RAM (SDRAM)) or a non-volatile memory (e.g., One Time Programmable Read Only Memory (OTPROM), Programmable ROM (PROM), Erasable and Programmable ROM (EPROM), Electrically Erasable and Programmable ROM (EEPROM), mask ROM, flash ROM, Not And (NAND) flash memory, and Not Or (NOR) flash memory).

According to an embodiment of the present disclosure, the internal memory 932 may be a Solid State Drive (SSD). The external memory 934 may be a flash drive such as Compact Flash (CF), Secure Digital (SD), micro-SD, Mini-SD, extreme Digital (xD), and Memory Stick. The external memory 934 may be connected to the electronic device 901 through various interfaces functionally. According to an embodiment of the present disclosure, the electronic device 901 may include a storage device (or storage medium) such as hard drive.

The sensor module 940 may measure physical quantity or evaluate the operation status of the electronic device 901 and convert the measured or evaluated information to an electric signal. The sensor module 940 may include at least one of a gesture sensor 940A, a Gyro sensor 940B, an atmospheric pressure sensor 940C, a magnetic sensor 940D, an acceleration sensor 940E, a grip sensor 940F, a proximity sensor 940G, a color sensor 940H (e.g., Red, Green, Blue (RGB) sensor), a bio sensor 940I, a temperature/humidity sensor 940J, an illuminance sensor 940K, and an Ultra Violet (UV) sensor 940M. Additionally, the sensor module 940 may include E-nose sensor (not shown), Electromyography (EMG) sensor (not shown), Electroencephalogram (EEG) sensor (not shown), Electrocardiogram (ECG) sensor (not shown), Infrared (IR) sensor (not shown), iris sensor (not shown), and fingerprint sensor (not shown). The sensor module 940 may further include a control circuit for controlling at least one of the sensors included therein.

The input device 950 may include a touch panel 952, a (digital) pen sensor 954, keys 956, and an ultrasonic input device 958. The touch panel 952 may be one of capacitive, resistive, infrared, microwave type touch panel. The touch panel 952 may include a control circuit. In the case of the capacitive type touch panel, it is possible to detect physical contact or approximation. The touch panel 952 may further include a tactile layer. In this case, the touch panel 952 may provide the user with haptic reaction.

The (digital) pen sensor 954 may be implemented with a sheet with the same or similar way as touch input of the user or a separate recognition sheet. The keys 956 may include physical buttons, optical key, and keypad. The ultrasonic input device 958 is a device capable of evaluating data by detecting sound wave through a microphone 988 and may be implemented for wireless recognition. According to an embodiment of the present disclosure, the electronic device 901 may receive the user input made by means of an external device (e.g., a computer or a server) connected through the communication module 920.

The display 960 (e.g., display module 150) may include a panel 962, a hologram device 964, and a projector 966. The panel 962 may be a Liquid Crystal Display (LCD) panel or an Active Matrix Organic Light Emitting Diodes (AMOLED) panel. The panel 962 may be implemented so as to be flexible, transparent, and/or wearable. The panel 962 may be implemented as a module integrated with the touch panel 952. The hologram device 964 may present 3-dimensional image in the air using interference of light. The projector 966 may project an image to a screen. The screen may be placed inside or outside the electronic device. According to an embodiment of the present disclosure, the display 960 may include a control circuit for controlling the panel 962, the hologram device 964, and the projector 966.

The interface 970 may include an HDMI 972, a USB 974, an optical interface 976, and a D-subminiature (D-sub) 978. The interface 970 may include the communication interface 160 as shown in FIG. 1. Additionally or alternatively, the interface 970 may include a Mobile High-definition Link (MHL) interface, an SD/MMC card interface, and infrared Data Association (irDA) standard interface.

The audio module 980 may convert sound to an electric signal and vice versa. At least a part of the audio module 980 may be included in the input/output interface 140 as shown in FIG. 1. The audio module 980 may process the audio information input or output through a speaker 982, a receiver 984, a earphone 986, and a microphone 988.

The camera module 991 is a device capable of taking still and motion pictures and, according to an embodiment of the present disclosure, includes at least one image sensor (e.g., front and rear sensors), a lens (not shown), and Image Signal Processor (ISP) (not shown), and a flash (e.g., LED or xenon lamp) (not shown).

The power management module 995 may manage the power of the electronic device 901. Although not shown, the power management module 995 may include a Power Management Integrated Circuit (PMIC), a charger Integrated Circuit (IC), a battery, and a battery or fuel gauge.

The PMIC may be integrated into an integrated circuit or SoC semiconductor. The charging may be classified into wireless charging and wired charge. The charger IC may charge the battery and protect the charger against overvoltage or overcurrent. According to an embodiment of the present disclosure, the charger IC may include at least one of wired charger and wireless charger ICs. Examples of the wireless charging technology includes resonance wireless charging and electromagnetic wave wireless charging, and there is a need of extra circuit for wireless charging such as coil loop, resonance circuit, and diode.

The battery gauge may measure the residual power of the battery 996, charging voltage, current, and temperature. The battery 996 may store or generate power and supply the stored or generated power to the electronic device 901. The battery 996 may include a rechargeable battery or a solar battery.

The indicator 997 may display operation status of the electronic device 901 or a part of the electronic device, booting status, messaging status, and charging status. The motor 998 may converts the electronic signal to mechanical vibration. Although not shown, the electronic device 901 may include a processing unit (e.g., GPU) for supporting mobile TV. The processing unit for supporting the mobile TV may be able to processing the media data abiding by the broadcast standards such Digital Multimedia Broadcasting (DMB), Digital Video Broadcasting (DVB), and media flow.

As described above, the text display method and apparatus of an electronic device of the present disclosure is advantageous in terms of reducing a number of page scrolls by discerning the paragraphs included in a text document and folding the paragraphs to present parts of the respective paragraphs.

Also, the text display method and apparatus of an electronic device of the present disclosure is advantageous in terms of improving the legibility of the text in such a way of enlarging, when a folded paragraph is stretched, the font size of the paragraph or highlighting the paragraph.

The above enumerated components of the electronic device of the present disclosure may be implemented into one or more parts, and the names of the corresponding components may be changed depending on the kind of the electronic device. The electronic device of the present disclosure may include at least one of the aforementioned components with omission or addition of some components. The components of the electronic device of the present disclosure may be combined selectively into an entity to perform the functions of the components equally as before the combination.

The term “module” according to various embodiments of the present disclosure, means, but is not limited to, a unit of one of software, hardware, and firmware or any combination thereof. The term “module” may be used interchangeably with the terms “unit,” “logic,” “logical block,” “component,” or “circuit.” The term “module” may denote a smallest unit of component or a part thereof. The term “module” may be the smallest unit of performing at least one function or a part thereof. A module may be implemented mechanically or electronically. For example, a module may include at least one of Application-Specific Integrated Circuit (ASIC) chip, Field-Programmable Gate Arrays (FPGAs), and Programmable-Logic Device known or to be developed for certain operations.

According to various embodiments of the present disclosure, the devices (e.g., modules or their functions) or methods may be implemented by computer program instructions stored in a computer-readable storage medium. In the case that the instructions are executed by at least one processor (e.g., processor 120), the at least one processor may execute the functions corresponding to the instructions. The computer-readable storage medium may be the memory 130. At least a part of the programming module may be implemented (e.g., executed) by the processor 120. At least part of the programming module may include modules, programs, routines, sets of instructions, and processes for executing the at least one function.

The computer-readable storage medium includes magnetic media such as a floppy disk and a magnetic tape, optical media including a Compact Disc (CD) ROM and a DVD ROM, a magneto-optical media such as a floptical disk, and the hardware device designed for storing and executing program commands such as ROM, RAM, and flash memory. The programs commands include the language code executable by computers using the interpreter as well as the machine language codes created by a compiler. The aforementioned hardware device may be implemented with one or more software modules for executing the operations of the various embodiments of the present disclosure.

The module or programming module of the present disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A text display method of an electronic device, the text display method comprising:
acquiring a text document including a plurality of paragraphs;
calculating text lengths of each of the plurality of paragraphs; and
displaying parts of texts of each of the plurality of paragraphs as single lines based on the calculated text lengths in order.

2. The method of claim 1, wherein the displaying of the parts of the texts comprises:
calculating a per-paragraph data length by analyzing structure of the text document;
calculating a single line length of a display of the electronic device; and
displaying, when the per-paragraph data length is longer than the single line length, the parts of the texts of the plurality of paragraphs.

3. The method of claim 1, wherein the displaying of the parts of the texts comprises:
hiding parts of the whole texts of the plurality of paragraphs by folding the plurality of paragraphs; and
presenting remaining parts of the whole texts on single lines respectively.

4. The method of claim 1, wherein the displaying of the parts of the texts comprises displaying, when one of the plurality of paragraphs represented by single lines is selected, whole text of the selected paragraph.

5. The method of claim 4, wherein the displaying of the whole text of the selected paragraph comprises differentiating the whole text of the selected paragraphs from other paragraphs in at least one of size, color, effect, and type.

6. The method of claim 1, wherein the displaying of the parts of the texts comprises:
analyzing a structure of the text document;
evaluating paragraph components in the text document;
determining text length of a single line per paragraph based on the text lengths of the plurality of paragraphs;
reformatting the text document into a structure with folded paragraphs based on a display resolution of the electronic device and a font size of the text of which length is determined; and
displaying the reformatted text document.

7. The method of claim 6, wherein the reformatting of the text document comprises generating a render tree reformatted based on a tree structure of the text document.

8. The method of claim 1, wherein the displaying of the parts of the texts comprises displaying a folding indicator indicating existence of hidden text per paragraph.

9. An electronic device comprising:
a communication module configured to communicate with at least one of other electronic devices and servers;
a display configured to display a text document including a plurality of paragraphs; and
a processor configured:
to analyze a structure of the text document,
to calculate text lengths of each of the plurality of paragraphs,
to control the display to display parts of texts of each of the plurality of paragraphs as single lines based on the calculated text lengths in order.

10. The electronic device of claim 9, wherein the processor comprises:
an analysis module which decomposes the text document into components of the text document, discerns the plurality of paragraphs by evaluating paragraph components among the components, and generates folding information per paragraph;
a reformat module which reformats the structure of the text document based on the folding information per paragraph, renders the reformatted information and text document, and updates the reformatted text document; and
a size adjustment module which displays the reformatted text document on the display and adjusts text size per paragraphs based on a number of folded paragraphs, screen resolution, text size, and whole text length of the text document.

11. The electronic device of claim 10, wherein the processor is further configured:
to calculate whole text length per paragraph in the text document,
to calculate single line length N of display screen, and
to generate, when the whole text length of each paragraph is greater than N, folding information per paragraph.

12. The electronic device of claim 11, wherein the processor is further configured to calculate the single line length N based on the resolution of the display and a text font size.

13. The electronic device of claim 10, wherein the processor is further configured to reformat the text document in which parts of the texts of each of the plurality of paragraphs are folded to be hidden and remaining parts of the text document are presented as single lines on the display screen.

14. The electronic device of claim 10, wherein the processor is further configured to control, when one of the plurality of paragraphs represented by single lines is selected, the display to display the whole text of the selected paragraph on the screen.

15. The electronic device of claim 10, wherein the processor is further configured to control the display to display the whole text of the selected paragraphs to be distinguished from other paragraphs in at least one of size, color, effect, and type.

16. The electronic device of claim 10, wherein the processor is further configured to control the display to display a folding indicator indicating existence of hidden text per paragraph.

17. The electronic device of claim 16, wherein, if the folding indicator of another folded paragraph is selected in a state where the whole text of an unfolded paragraph is displayed, the processor is further configured:
to fold unfolded paragraphs, and
to unfold the other folded paragraph corresponding to the selected folding indicator.
